(19) United States
(12) Patent Application Publication
(10) Pub. No.: US 2011/0207026 A1
(43) Pub. Date: Aug. 25, 2011

(54) FUEL CELL BIPOLAR PLATE ASSEMBLY

(75) Inventors: CHUNG-JEN TSENG, TAOYUAN COUNTY (TW); BIN-TSANG TSAI, CHANGHUA COUNTY (TW); FENG-CHANG CHEN, TAOYUAN COUNTY (TW)

(73) Assignee: NATIONAL CENTRAL UNIVERSITY, TAOYUAN COUNTY (TW)

(21) Appl. No.: 12/832,455

(22) Filed: Jul. 8, 2010

(30) Foreign Application Priority Data
Feb. 22, 2010 (TW) 099105091

(51) Int. Cl. H01M 8/04

(52) U.S. Cl. 429/515

(57) ABSTRACT

A fuel cell bipolar plate assembly is revealed. The bipolar plate assembly includes a bipolar plate and a diffusion member. The bipolar plate consists of at least an inlet, at least an outlet, and a flow channel. The flow channel further includes at least one storage area used for disposition of the diffusion member made of porous material. The fuel of the fuel cell is distributed uniformly due to excellent permeability of the porous material. Moreover, by the design of zoning, the efficiency of fuel at corners is improved. Thus the fuel efficiency is increased and the fuel cell efficiency is further improved.

### BACKGROUND OF THE INVENTION

1. Fields of the Invention

The present invention relates to a bipolar plate assembly, especially to a fuel cell bipolar plate assembly.

2. Descriptions of Related Art

A fuel cell is an electrochemical device that converts chemical energy of fuels into an electrical power. After fuel and an oxidant being sent to a reaction area through flow channels, they are oxidized at the anode and reduced at the cathode by a catalyst layer respectively. During the conversion processes, freed electrons produce an electrical current flowing in an external circuit so as to do work. The higher energy conversion efficiency of the fuel cell is, the more fuel and the oxidant are required. One fuel cannot be sent to the reaction area efficiently or reaction products cannot flow out of the fuel cell, the efficiency of the fuel cell is reduced significantly. Moreover, fuel cells are among the most promising technology for all countries that focus on developing new energy sources.

Refer to FIG. 1, a schematic drawing showing structure of a conventional fuel cell is revealed. As shown in figure, the fuel cell mainly consists of a membrane electrode assembly 10 and two bipolar plates 20 on two sides of the membrane electrode assembly 10. The membrane electrode assembly 10 includes a proton exchange membrane 12 whose two sides are respectively coated with a catalyst layer 12a and a catalyst layer 12b. And a gas diffusion layer 14 is disposed on an outer side of the catalyst layer 12a and of the catalyst layer 12b. An inner side of each bipolar plate20, corresponding to each other, is arranged with a fuel flow channel 22 so as to provide hydrogen and oxygen that enters an anode and a cathode on two sides to have chemical reactions through the membrane electrode assembly 10. The disposition of the fuel flow channels 22 on the inner side of each bipolar plate 20 is to make oxygen and hydrogen flow smoothly and contact with the membrane electrode assembly 10 evenly. Thus the length of the fuel flow channels 22 and the shape as well as the size of the cross section of the fuel flow channels 22 all have effects on the chemical reactions between fuel and the membrane electrode assembly 10 and further affect the fuel cell efficiency.

New designs are required to improve fuel cell performance available now. Especially for flow channels of a bipolar plate of the fuel cell, how to provide uniform fuel distribution when the bipolar plate is applied to fuel cells with larger areas is still a problem. Besides spiral design that improves the ratio of the reacting gas, most of new designs and improvements of the flow channel of the bipolar plate available now focus on the internal reactant flow channel.

Refer to Taiwanese Pat. Pub. No. 200633295, a flow channel design for fuel cell bipolar plate is revealed. The ratio of fuel gas reacted is improved by a spiral design and such design also achieves more uniform humidity distribution of a proton exchange membrane in the fuel cell. The performance of the fuel cell is further enhanced.

Refer to Taiwanese Pat. Pub. No. M292791, a fuel cell flow field plate is disclosed. A surface of a flow field plate includes a plurality of flow channels. Each flow channel consists of a flow channel inlet connected with a gas inlet, a flow channel outlet connected with a gas outlet and a flow channel body arranged between the flow channel inlet and the flow channel outlet. The diameter of the flow channel body of each flow channel is larger than that of the flow channel outlet so that a pressure drop between each flow channel inlet and outlet is increased better water drainage and better fuel cell performance.

Refer to Taiwanese Pat. Pub. No. 200908425, a net-like flow channel formed by a plurality of inlet channels, divided channels, middle-part channels, and outlet channels can reduce a pressure drop between the inlet channel and the outlet channel and stabilize flow velocity in the channel so as to improve the output power of the fuel cell.

Refer to Taiwanese Pat. Pub. No. 200539497, a plurality of gas channels are used for gas input and output and at least one flow channel that is disposed on a lateral surface of a plate and is connected between the gas channels. A wall surface of the flow channel is a curved surface so as to prevent water from being accumulated or trapped in the flow channel.

Refer to Taiwanese Pat. Pub. No. M 293537, a flow channel is formed by a plurality of continuous cross sections so as to change flow rate and pressure of reactant in the flow channel and further control concentration and a potential change of gas reactants and the efficiency of reactants. Thus a uniform electrochemical reaction occurs.

In addition, refer to Taiwanese Pat. Pub. No. 553496, a porous bipolar plate of a thin film fuel cell is revealed. Reactant gas is distributed evenly by porous material with high permeability. There is no need to design other flow channels.

The above six types of bipolar plates have similar improvements. Although the movement of gas flow is improved, it is still limited by the design of the flow channel of the bipolar plate and the improvement of the fuel cell efficiency is also affected. The designs in above patents only improve part of the above shortcomings. However, there is still a space for improvement of the bipolar plate with large reaction area or uniform fuel distribution in the bipolar plate.

Thus there is a need to develop a fuel cell bipolar plate assembly that achieves a uniform distribution of fuel while being used in a larger fuel cell with large reaction area and improves the fuel cell efficiency.

### SUMMARY OF THE INVENTION

Therefore it is a primary object of the present invention to provide a fuel cell bipolar plate assembly that includes a bipolar plate and a diffusion member. The bipolar plate is disposed with a flow channel having at least one storage area. The diffusion member is arranged at the storage area. The diffusion member is made of porous material. The fuel of the fuel cell is distributed uniformly due to excellent permeability of the porous material. Thus the fuel use efficiency is enhanced and the fuel cell efficiency is further increased.

It is another object of the present invention to provide a fuel cell bipolar plate assembly in which a flow channel of a bipolar plate is arranged with a plurality of storage areas. Moreover, the cross sectional area of each first branch flow area is proportional to the distance between the first branch flow area and an inlet. Or the cross sectional area of each second branch flow area connected with the storage area is proportional to the distance between the second branch flow area and an outlet. By such zoning design, the fuel use efficiency at each corner is improved and more uniform distribution of the fuel of the fuel cell is achieved. Therefore, not only the fuel use efficiency is increased, the fuel cell efficiency is also improved.

In order to achieve above objects, a fuel cell bipolar plate assembly of the present invention includes a bipolar plate and a diffusion member. The bipolar plate consists of at least an inlet, at least an outlet, and a flow channel whose two ends are connected with the inlet and the outlet. The flow channel further includes a storage area used for receiving the diffusion member made of porous material. The fuel of the fuel cell is distributed uniformly owing to excellent permeability of the porous material and the fuel efficiency is further improved. Thus the fuel cell efficiency is increased.

Moreover, the flow channel is arranged with a plurality of storage areas and each storage area is disposed with one diffusion member. The flow channel includes a first main flow area, a plurality of first branch flow areas, a plurality of second branch flow areas and a second main flow area. The first main flow area is connected with the inlet and the first branch flow areas are connected between the first main flow area and the storage areas while the second branch flow areas are arranged at and connected with the storage areas and the second main flow area is connected with and disposed between the second branch flow areas and the outlet. The cross sectional area of each first branch flow area is proportional to the distance between the first branch flow area and the inlet. The cross sectional area of each second branch flow area is also proportional to the distance between the second branch flow area and the outlet. By the design of zoning, the efficiency of fuel at corners is increased and the distribution of the fuel becomes more uniform. Therefore, not only the fuel efficiency is increased, the fuel cell efficiency is further improved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing structure of a conventional fuel cell;

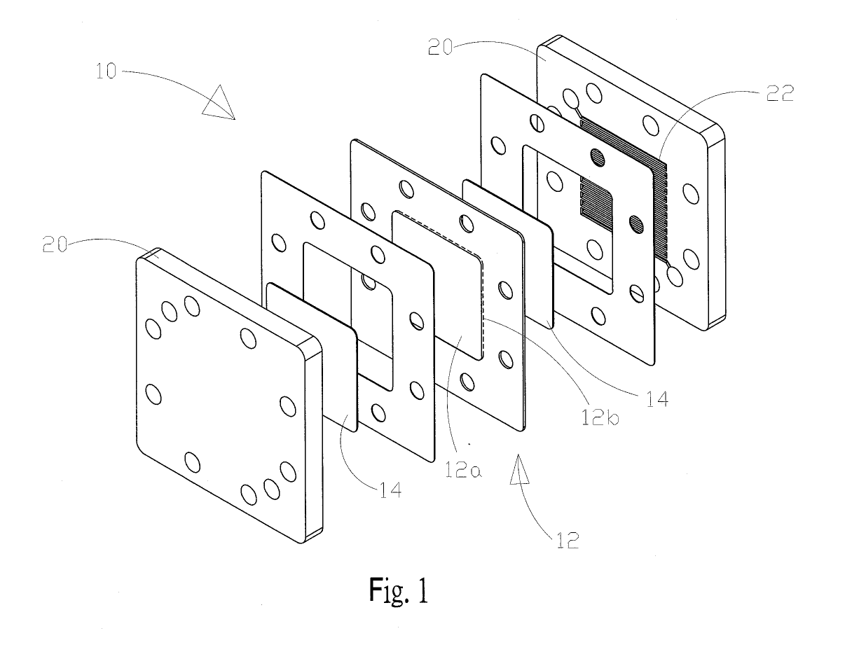

FIG. 2A is a perspective view of an embodiment of a fuel cell bipolar plate assembly according to the present invention;

FIG. 2B is an explosive view of an embodiment of a fuel cell bipolar plate assembly according to the present invention;

FIG. 3A is a perspective view of another embodiment of a fuel cell bipolar plate assembly according to the present invention;

FIG. 3B is an explosive view of another embodiment of a fuel cell bipolar plate assembly according to the present invention;

FIG. 3C is a front view of another embodiment of a fuel cell bipolar plate assembly according to the present invention;

FIG. 4 is an explosive view of a further embodiment of a fuel cell bipolar plate assembly according to the present invention;

FIG. 5A is a perspective view of a further embodiment of a fuel cell bipolar plate assembly according to the present invention;

FIG. 5B is a partial enlarged view of the embodiment in FIG. 5A.

### DETAILED DESCRIPTION OF THE PREFERRED EMBODIMENT

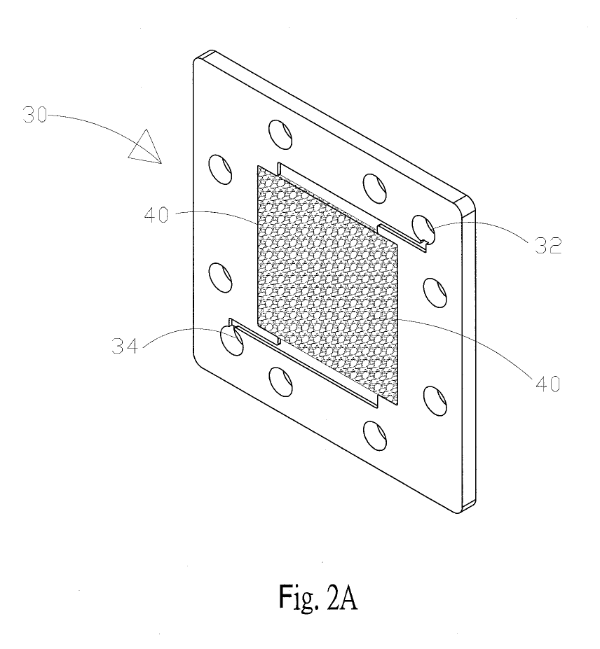

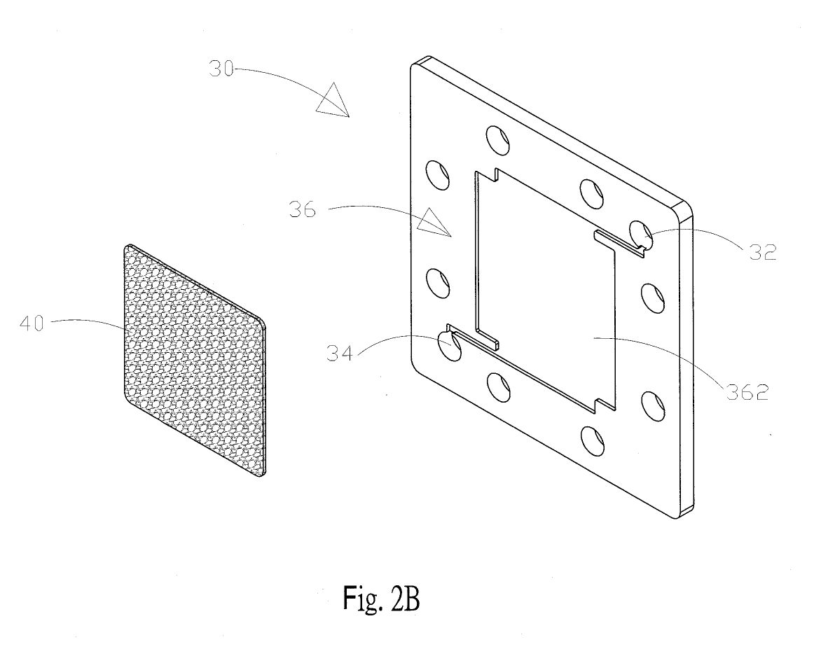

Refer to FIG. 2A and FIG. 2B, a perspective and an explosive view of an embodiment of a fuel cell bipolar plate assembly according to the present invention are disclosed. As shown in figures, the bipolar plate assembly of the fuel cell of the present invention is composed of a bipolar plate 30 and a diffusion member 40. The bipolar plate 30 includes at least an inlet 32, at least an outlet 34, and a flow channel 36. The two ends of the flow channel 36 are respectively connected with the inlet 32 and the outlet 34. The flow channel 36 includes a storage area 362 that is used for loading the diffusion member 40. The diffusion member 40 is made of porous material. Due to excellent permeability of the porous material, fuel of the fuel cell is distributed evenly. When fuel of the fuel cell flows into the storage area 362 through the inlet 32, the fuel is diffused and distributed evenly by the diffusion member 40. The fuel use efficiency is increased and the efficiency of the fuel cell is further improved.

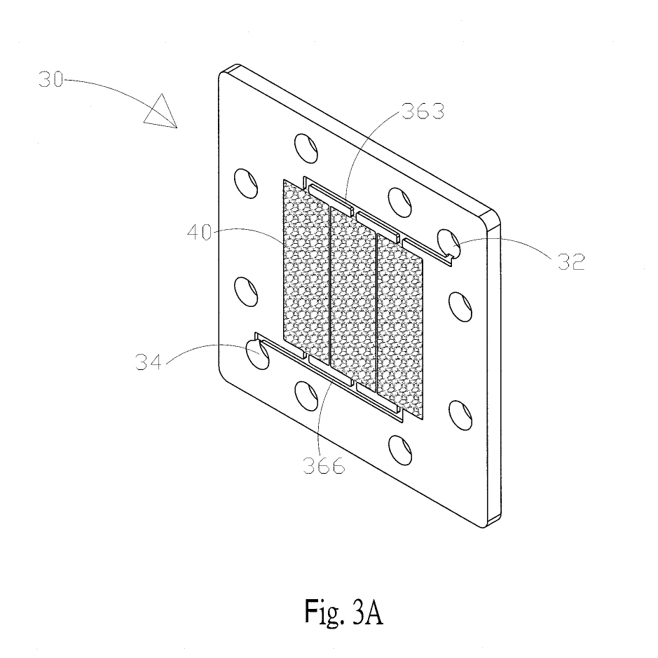

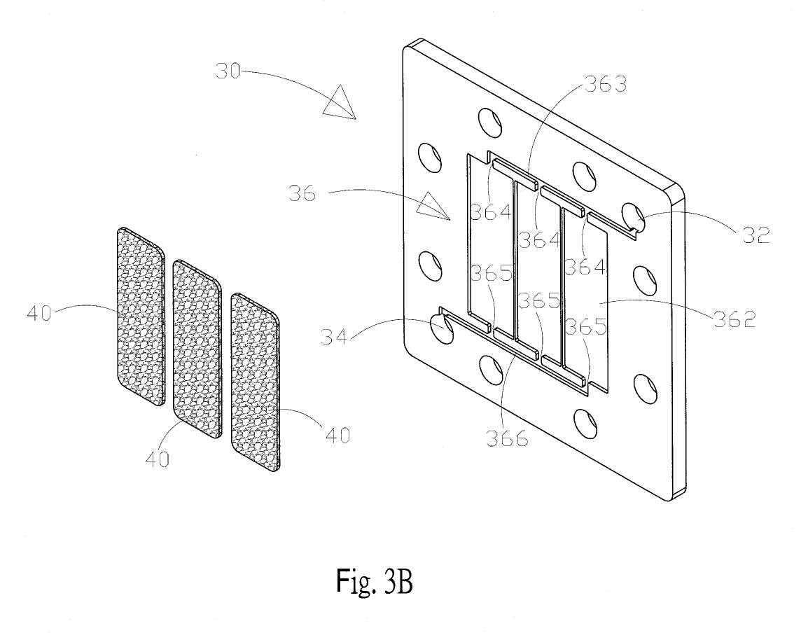

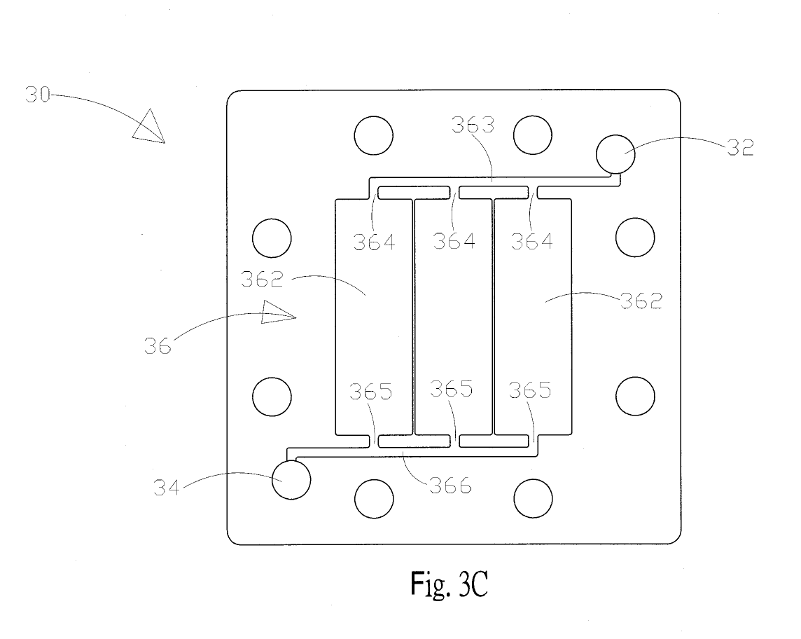

Refer from FIG. 3A to FIG. 3C, another embodiment of the present invention is revealed. The difference between this embodiment and the above one in FIG. 2A is in the structure of the flow channel 36. The flow channel 36 in this embodiment further includes a plurality of storage areas 362 and each storage area 362 is disposed with one diffusion member 40. The flow channel 36 consists of a first main flow area 363, a plurality of first branch flow areas 364, a plurality of second branch flow areas 365 and a second main flow area 366. The first main flow area 363 is connected with the inlet 32 and the first branch flow areas 364 are connected with and disposed between the first main flow area 363 and the storage areas 362. The second branch flow areas 365 are arranged at and connected with the storage areas 362 while the second main flow area 366 is connected with and disposed between the second branch flow areas 365 and the outlet 34.

When fuel of the fuel cell flows into the first main flow area 363 through the inlet 32 and then splits from each first branch flow area 364 into each storage area 362. The fuel is evenly distributed by the diffusion member 40 while the rest fuel flows out of each second branch flow area 365 to be collected in the second main flow area 366 and then exhausted through the outlet 34. In this embodiment, by the arrangement of the plurality of storage areas 362 at the flow channel 36 and the diffusion members 40 on the storage areas 362, the fuel of the fuel cell is distributed more uniformly. This embodiment is suitable to be used in a large volume fuel cell so as to avoid uneven distribution of the fuel, increase fuel use efficiency and further improve the efficiency of the fuel cell.

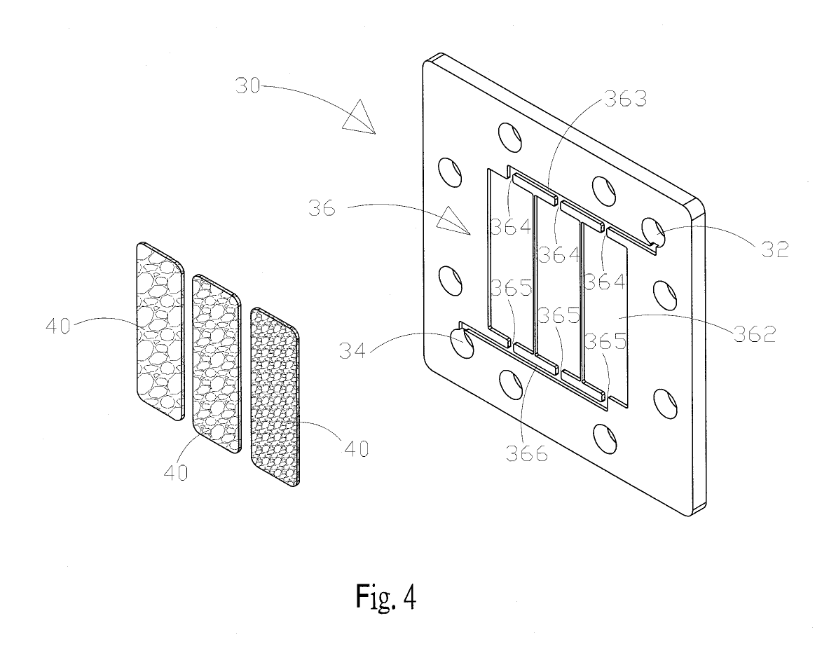

Refer to FIG. 4, an explosive view of a further embodiment according to the present invention is disclosed. As show in the figure, the difference between this embodiment and the above one in FIG. 3B is in that the diffusion members 40 in this embodiment have different porosity. During fuel delivery processes in the flow channel 36, firstly the fuel flows into the first main flow area 363 through the inlet 32 and then splits from the first main flow area 363 into each first branch flow area 364. Then the fuel is firstly sent from the first branch flow area 364 that is closest to the inlet 32 to the storage area 362 connected therewith so that the fuel delivery rate of the first branch flow area 364 closest to the inlet 32 is the fastest. On the other hand, the fuel delivery rate of the first branch flow area 364 far away from the inlet 32 is slower. Thus in this embodiment, the pore size of the diffusion member 40 closer to the inlet 32 is reduced while the pore size of the diffusion member 40 farther from the inlet 32 is increased. That means the porosity of the diffusion member 40 is proportional to the distance between the diffusion member 40 and the inlet 32 so as to slow down the fuel delivery rate of the first branch flow area 364 closer to the inlet 32 and speed up the fuel delivery rate of the first branch flow area 364 farther from the inlet 32. Thus non-uniform distribution of the fuel can be avoided, the fuel use efficiency is improved, and the electric power output efficiency of the fuel cell is further increased.

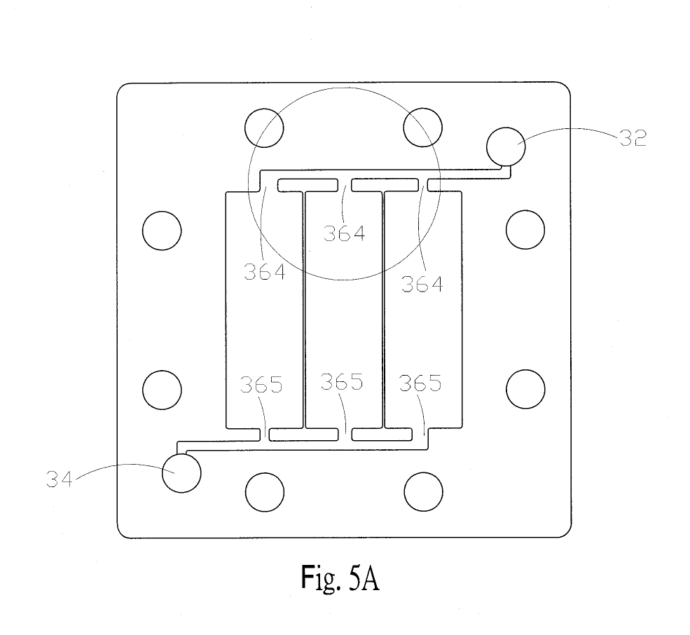

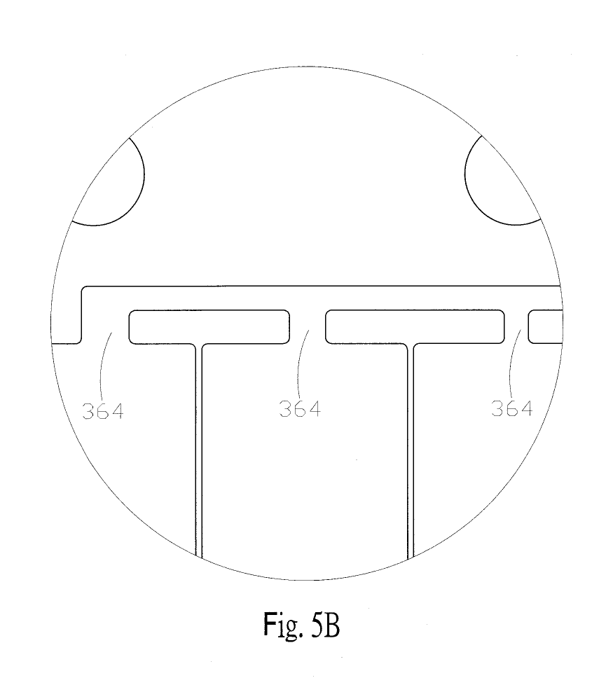

Refer to FIG. 5A and FIG. 5B, a perspective view and a partial enlarged view of a further embodiment according to the present invention are revealed. The difference between this embodiment and the one in FIG. 3C is in the cross sectional area of the first branch flow area 364. In this embodiment, the cross sectional area of each first branch flow area 364 is proportional to the distance between the first branch flow area 364 and the inlet 32 due to different fuel delivery rate of each first branch flow area 364. That means the cross sectional area of the first branch flow area 364 closer to the inlet 32 is reduced and the cross sectional area of the first branch flow area 364 farther from the inlet 32 is increased so as to slow down the fuel delivery rate of the first branch flow area 364 closer to the inlet 32 and speed up the fuel delivery rate of the first branch flow area 364 farther from the inlet 32. Thus the fuel distribution is more uniform and the fuel use efficiency is increased. Therefore, the electric power output efficiency of the fuel cell is improved.

Similarly, the cross sectional area of each second branch flow area 365 is proportional to the distance between the second branch flow area 365 and the outlet 34 so as to reduce the fuel delivery rate of the first branch flow area 364 closer to the inlet 32 and increase the fuel delivery rate of the first branch flow area 364 farther from the inlet 32 for uniform distribution of the fuel. Besides the diffusion members 40 made of porous material, the zoning design also improves fuel use efficiency at each corner. Thus the fuel cell efficiency is further increased.

In summary, a fuel cell bipolar plate assembly of the present invention includes a bipolar plate and a diffusion member. The bipolar plate consists of at least one inlet, at least one outlet and a flow channel. The flow channel is respectively connected with the inlet and the outlet on two ends thereof. The flow channel includes at least one storage area that is disposed with the diffusion member. The diffusion member is made of porous material with excellent permeability so as to make the fuel of the fuel cell distribute evenly. Thus the fuel use efficiency is increased and the fuel cell efficiency is further improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A fuel cell bipolar plate assembly comprising:
a bipolar plate having at least an inlet, at least an outlet, and a flow channel whose two ends are connected with the inlet while the outlet and the flow channel including a storage area; and
a diffusion member made of porous material and disposed on the storage area.

2. A fuel cell bipolar plate assembly comprising:
a bipolar plate having at least an inlet, at least an outlet, and a flow channel whose two ends are connected with the inlet while the outlet and the flow channel including a plurality of storage areas; and
a plurality of diffusion members made of porous material and disposed on the storage area respectively.

3. The device as claimed in claim 2, wherein the flow channel includes
a first main flow area connected with the inlet,
a plurality of first branch flow areas that are connected with and arranged between the first main flow area and the storage areas,
a plurality of second branch flow areas that are arranged at and connected with the storage areas and,
a second main flow area that is connected with and disposed between the second branch flow areas and the outlet.

4. The device as claimed in claim 3, wherein the cross sectional area of each first branch flow area is proportional to the distance between the first branch flow area and the inlet.

5. The device as claimed in claim 3, wherein the cross sectional area of each second branch flow area is proportional to the distance between the second branch flow area and the outlet.

6. The device as claimed in claim 2, wherein porosity of the diffusion members is proportional to the distance between the diffusion member and the inlet.
